(19) United States
(12) Patent Application Publication
(10) Pub. No.: US 2009/0019846 A1
(43) Pub. Date: Jan. 22, 2009

(54) METHOD AND SYSTEM FOR ELECTRICAL AND MECHANICAL POWER GENERATION USING STIRLING ENGINE PRINCIPLES

(76) Inventors: Guy Silver, Sunnyvale, CA (US); Juinerong Wu, Sunnyvale, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/577,163

(22) PCT Filed: Oct. 7, 2005
(86) PCT No.: PCT/US05/36391

§ 371 Date: Apr. 12, 2007

Related U.S. Application Data
(63) Continuation-in-part of application No. 10/963,274, filed on Oct. 12, 2004.

(51) Int. Cl. F02G 1/043

(52) U.S. Cl. 60/517

(57) ABSTRACT

A heat engine enclosed in a housing has two zones maintained at different temperatures. The first zone (“hot zone”) receives heat energy from an external power source. The second zone (“cold chamber zone”) is connected to the hot zone by two conduits, such that a fluid (e.g., air, water, or any other gas or liquid) filling the two zones can circulate between the two zones. The expansion of the fluid in the hot zone and the compression of the fluid in the cold zone drive a turbine to provide a power output. The fluid may be pressurized to enhance efficiency. In one embodiment, the turbine propels an axle in a rotational motion to transmit the power output of the heat engine to an electrical generator outside of the heat engine's housing. In one embodiment, the turbine includes a first set of blades and a second set of blades located in the hot zone and the cold zone, respectively. The blades may each have a flat profile having two unequal surfaces, such that the turbine rotates in preferentially in one direction.

### BACKGROUND OF THE INVENTION

1. Field of the Invention

The present invention relates to applying Stirling engine principles to the design and use of power conversion equipment. In particular, the present invention relates to applying Stirling engine principles for electrical and mechanical power generation, especially in the direct current (DC) mode or in the alternating current (AC) modes.

2. Discussion of the Related Art

The Stirling engine is a heat engine that operates by converting the heat energy which flows between two portions of the heat engine having different temperatures into mechanical power. A typical Stirling engine uses the heat energy to drive a coordinated and reciprocating motion of a set of pistons. Numerous designs of Stirling engines can be found in the prior art, including: U.S. Pat. Nos. 6,578,359, 6,050,092, 6,195,992, 6,735,946 and 6,164,263. The designs of these Stirling engine are typically complex and include numerous moving parts. Consequently, these designs are costly to manufacture and their efficiencies are low.

### SUMMARY

The present invention provides a heat engine enclosed in a housing having two zones maintained at different temperatures. The first zone (“hot zone”) receives heat energy from an external power source. The second zone (“cold zone”) is connected to the hot zone, such that a fluid (e.g., air, water, or any other gas or liquid) filling the two zones can circulate between the two zones. The expansion of the fluid in the hot zone and the compression of the fluid in the cold zone provide a symmetrical thermodynamic cycle to drive a turbine to provide a power output. The fluid may be pressurized to enhance efficiency.

In one embodiment, the turbine propels an axle in a rotational motion to transmit the mechanical power output of the heat engine. In one embodiment, the turbine propels an axle in a rotational motion to transmit the power output of the heat engine to an electrical generator outside of the heat engine's housing. In one embodiment, the turbine includes a first set of blades attached to a plate located in the hot zone and a second set of blades attached to a plate located in the cold zone. The blades may each have a flat profile having two unequal surfaces, such that the turbine rotates preferentially in one direction. Blade set 103a and blade set 103b of the turbine rotate as a result of fluid flow pressure between the two zones of different temperatures within housing 107. According to another embodiment, turbine blades rotate and create vortices in the working fluid. The velocity of the working fluid put the turbine into doing useful work. The torque in the rotary motion of the turbine, therefore, may be used to drive machinery (e.g., a generator) through a power axle or a shaft. In one embodiment, the electrical generator includes one or more magnets in rotational motion according to the rotational motion of the axle, and one or more conductive coils coupled to the magnetic fields of the one or more magnets. The amount of coupling between the magnets and the coils may be controlled by a step motor moving the coils into different positions relative to the magnets. In one embodiment, the electrical generator delivers AC power. Alternatively, DC power may be provided by either rectifying the AC power, or by selectively coupling those coils that have an instantaneous positive voltage relative to a ground terminal. To synchronize the coil selection, a position sensor may be provided to sense the positions of the magnets. In one embodiment, the position sensor includes a light sensitive sensor, a light emitting diode and a light reflector.

According to one embodiment of the present invention, a temperature sensor may be used to control the power output of the heat engine. A signal output of the temperature sensor indicates a temperature difference between the hot and cold zones. Based on this output signal of the temperature sensor, a control circuit adjusts the coupling between the magnets and the coils in the electrical generator. In an AC power generation application, a control circuit senses to the frequency of the electrical generator's output power to control the output power of the electrical generator.

In one embodiment, adding power output is achieved using thermal couples and thermionic devices. The thermal couple takes advantage of the temperature difference between the hot and cold zones. The thermionic devices extract heat from the housing of the heat engine. These devices may be stored in an insulated area between two plates separating the hot and cold zones.

The present invention provides a heat engine in which the gas or fluid transferring heat between the hot and cold zones is used to drive the turbine, resulting in low power loss in the energy conversion process. In addition, the housing provides fluid flow between the hot zone and the cold zone through a center shaft and a peripheral space so as to allow 100% component use with no dead time. The cylindrical symmetry of the heat engine provides stability with minimum vibration and an absence of drag during operation. The heat engine of the present invention has a simple design with few moving parts, without the requirements of a displacer, a piston or a regenerator. Thus, the heat engine of the present invention is light weight, low component cost and easy to maintain.

A heat engine of the present invention may be used to power an automobile or another vehicle. It can also be incorporated, for example, in any application in which a source of heat energy is provided (e.g., fuel cells or energy recovery from combustion of waste).

In addition, the control system of the present invention provides a consistent output power to enhance fuel efficiency.

The present invention is better understood upon consideration of the detailed description below and the accompanying drawings.

### BRIEF DESCRIPTION OF THE DRAWINGS

FIG. 1 shows heat engine 100 receiving solar energy from a solar reflector 160, in accordance one embodiment of the present invention.

FIG. 2 shows one implementation of heat engine 100 of FIG. 1 in a cross-sectional view.

FIG. 3 represents the cross-sectional view of heat engine 100 along line C-C′, viewed from the bottom (the cross-sectional view of heat engine 100 along line B-B′, viewed from top, shows radially outward flows).

FIG. 4 is a cross section view of heat engine 100 along line D-D′, showing center axle 101, magnets 108 and coils 109.

FIG. 5 shows control circuit 501 capable of controlling the output power based on an operating temperature difference.

FIG. 6 shows multiplexing switch 601 provided to selectively couple each of terminal x to output terminal y.

### DETAILED DESCRIPTION OF THE PREFERRED EMBODIMENTS

The present invention provides a heat engine, operating under Stirling engine principles, for converting heat energy into mechanical and electrical energy. The electrical energy derived using a heat engine of the present invention may be in the form of alternating current (AC) power, for immediate distribution, or in the form of direct current (DC) to allow storage or other applications.

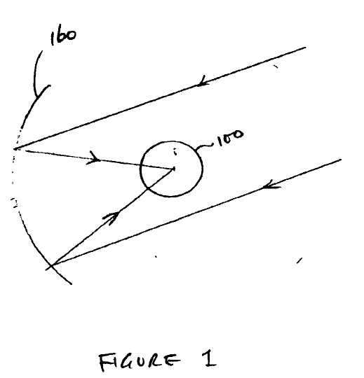

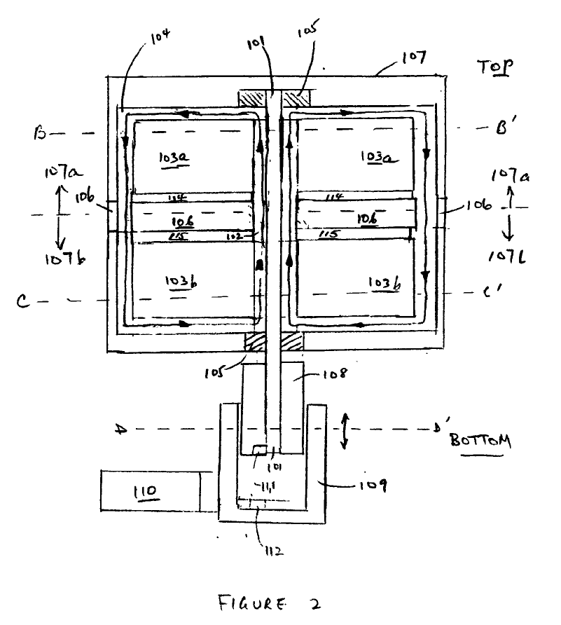

The heat engine of the present invention may operate with any source of heat energy, including solar, geothermal, fossil, landfill recovered or other fuels. FIG. 1 shows heat engine 100 receiving solar energy from a solar reflector 160, in accordance one embodiment of the present invention. One embodiment of heat engine 100 of FIG. 1 is shown in a cross section view in FIG. 2. As shown in FIG. 2, heat energy 100 includes an external housing 107 which seals a hot portion or zone 107a and a cold portion or zone 107b. In this detailed description, the terms “hot” and “cold” are relative. A heat engine of the present invention will operate as long as there is a sufficient temperature difference between the hot portion and the cold portion. Further, the upper and lower portions of FIG. 2 are labeled “top” and “bottom”, respectively, merely to facilitate reference in this detailed description. A heat engine of the present invention is not limited by its position in any orientation.

Hot portion 107a (“hot zone”) and cold portion 107b (“cold zone”) are insulated from each other by insulating zone 106. Except for insulating zone 106, housing 107 may be metallic (e.g., steel) to allow rapid and even heat distribution. A turbine in a heat engine, according to the present invention, may be located in any suitable location inside the hot zone 107a and the cold zone 107b of the housing 100, to provide the output power of the engine. The turbine may be in any suitable size or material, depending on the application of the heat engine 100. In one embodiment, heat engine 100 includes turbine 103; in the implementation shown in FIG. 2, turbine 103 includes two sets of blades, labeled 103a and 103b, respectively, which are connected by center axle 101. Blade set 103a and blade set 103b are housed within the hot and cold zones, respectively. Blade set 103a and blade set 103b are designed to create torque on the turbine from the motion of the fluid. Blade set 103a and blade set 103b may be any suitable size, curvature or made of any material, depending on the application of the heat engine 100. Blade sets 103a and 103b are preferably made of metal to allow even and rapid heat distribution, and may function as extra thermal transfer surfaces as a heat source or a heat sink. In this embodiment, blade sets 103a and 103b are provided on support plates 114 and 115 respectively. The area between support plates 114 and 115 may be considered an open area with support plates 114 and 115 on the top and bottom, or an area enclosed by support plates 114 and 115. Furthermore, support plates 114 and 115 may be provided as an integrally formed structure. Support plates 114 and 115 may act as an insulator (i.e. being made of a thick layer of insulated material or filled with an insulation material). Blade sets 103a and 103b may also be attached to structures within hot zone 107a and cold zone 107b, for example, to support plate 114, to support plate 115, to center axle 101.

FIG. 3 represents the cross-sectional view of heat engine 100 along line C-C′, viewed from the bottom. The arrows represent the direction of working fluid movement. It shows that that working fluid moving radially inwards toward the center of cold zone 107b. The direction of the working fluid viewed from the cross-sectional view of heat engine 100 along line B-B′, viewed from the top, would be radially outwards and moving away from the center of hot zone 107a. In relation, the cross-sectional view of FIG. 2 represents a cross-section along line A-A′ of FIG. 3. Blade sets 103a and 103b are each provided a rounded contour, such that one side of the blade has a larger cross-section than the other, to allow the blades to rotate in a predetermined direction. The difference in surface area is not necessary, but may provide some advantage in some applications, such as ease in starting up. Blade sets 103a and 103b provide large surface areas for heat transfer, and may have an aerodynamic design. An aerodynamic design creates a pressure difference as fluid flows from one side of the blade faster than the other side of the blade. Thus, heat engine 100 has a high surface to volume ratio to enhance efficiency.

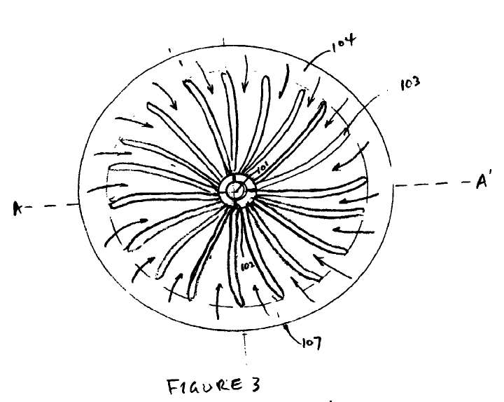

Center axle 101 is unsheathed in air shaft 102 that runs from top to bottom along the entire lengths of hot portion 107a and cold portion 107b of housing 107, connecting the hot and cold zones. The hot and cold zones are also connected by annular air space 104 along the circumference of the outer wall of housing 107. Center axle 101 is held by bearings 105, which allow center axle 101—and thus blade sets 103a and 103b also—to rotate about its center axis. Because the contact points between bearings 105 and center axle 103 are the only locations in heat engine 100 which experience mechanical wear and tear, heat engine 100 has a long service life and a low service requirement and thus easily maintained. A portion of center axle 101 extends outside of housing 107. Cylindrical magnet 108 attaches to and rotates with this portion of center axle 101 which extends outside of housing 107. One or more coils 109 surround magnet 108. Coils 109 may be driven by step-motor 110 in an up and down motion to vary the amount of magnet flux coupling the magnetic field of magnet 108. FIG. 4 is a cross sectional view of heat engine 100 along line D-D′, showing center axle 101, magnet 108 and coils 109. As shown in FIG. 4, coils 109 may include one or more coils with their respective output terminals (labeled “x”) and a common ground terminal. FIG. 2 also shows reflector 111 provided with magnet 108, and a position sensor 112. Position sensor 112 includes a light emitting diode (LED) and a sensor sensitive to light reflected from reflector 111. Each of coils 109 may be provided with a position sensor, so that a control circuit may be able to determine the frequency and the phase of the alternating electrical current induced in the coil by the magnet.

In this embodiment, when coils 109 includes more than one coil (as may be desirable for DC power generation), a multiplexing switch 601 may be provided, as shown in FIG. 6, to selectively couple each of terminal x to output terminal y according to the phase of the alternating electrical current in each coil. If only one coil is present in coils 109, the single output terminal x of coils 109 is directly coupled to terminally.

During operation, as heat builds up in hot portion 107a of housing 107, the expanding fluid in the hot zone rises and pushes against blade set 103a on support plate 114. Thus, turbine 103 begins to rotate about the axis of center axle 101 due to the torque of the expanding fluid. The expanding fluid moves radially outward towards the periphery and into the cold zone 107b via annular air space 104. As the expanding fluid enters into cold zone 107b, the fluid in cold zone 107b contracts by a cooling mechanism (e.g., the walls of housing 107 in cold zone 107b may include pipes circulating a cooling fluid). The contracting fluid draws the expanding fluid into cold zone 107b. As blade set 103b on support plate 115 in cold zone 107b is connected by center axle 101 to rotating blade set 103a on support plate 114, blade set 103b rotates at the same angular speed as blade set 103a, thereby contributing to the torque rotating turbine 103. The cooled fluid in cold zone 107b is drawn by convection radially towards center axle 101 and is forced into hot zone 107a via air shaft 102. Thus, a circulation of fluid is established which flows radially outwards in hot zone 107a, enters cold zone 107b via annular air space 104, flows radially inwards in cold zone 107b and returns to hot zone 107a through air shaft 102. In this process, the relatively hot fluid from hot zone 107a that expands and flows into cold zone 107b is cooled in cold zone 107b, while the relatively cold fluid from cold zone 107b is heated in hot zone 107a. During an engine cycle, the working fluid urges on all the blades of blade set 103a or all the blades of blade set 103b at the same time. Each blade of blade set 103a or blade set 103b contributes work at the same time. Therefore, fluid control structures such as nozzles and pipes, which are generally used in fluid driven system to direct the working fluid to a particular portion of the turbine so as to provide an impulse, are not necessary in a heat engine of the present invention.

As magnet 108 rotates with center axle 101, the result varying magnetic field induces one or more electrical currents in coils 109. This electric current can be used to generate AC or DC electrical power, as discussed in further detail below. A temperature difference between hot zone 107a and cold zone 107b may be established, such that the output power and the heat dissipated from housing 107 equals the input power. Cold zone 107b may be cooled and maintained at a pre-determined temperature by fluid (e.g., air). Such fluid may flow in channels provided in walls of housing 107b, or by other means known to those skilled in the art. Efficiency for the heat transfer may be enhanced by pressurizing the hot and cold zones. Alternatively, rather than using air, other gases may also be used.

According to another embodiment, the working fluid flows through blade sets 103a and 103b and put blade set 103a and 103b into a preferred rotational direction to maximize torque generation. During operation, as heat builds up in hot zone 107a, the expanding working fluid in hot zone 107a urges against blades set 103a to create a torque to cause turbine 103 to rotate. The rotation of blades set 103a interacts with the working fluid movement and may impact the direction of the working fluid, or other fluid characteristics that change within the working fluid path. Such characteristics, for example, may include the working fluid velocity, direction, and volume. Blade set 103a or blade set 103b may rotate and bring the working fluid into rotational motion resulting in vortex or vortices forming in the working fluid. Vortices are a result of a rotational movement of the working fluid rotating about a center. Rotational working fluid has angular momentum and may be used to rotate the next blade set in the working fluid path. A continuous rotational working fluid can be maintained by a series of rotational working fluid portions supported by turbine blade sets. Thus, each portion of the working fluid adds an angular momentum to the working fluid. In addition, the rotational movement of the working fluid may be carried through one or more portions of the working fluid path to the entire working fluid path. A continuous rotational working fluid in an engine can be achieved by collaboration of turbine blade sets and the curvature of the working fluid path. Thus, the angular momentum of working fluid can be accumulated and used to drive turbine blade sets. Therefore, the expansion, contraction and rotational movements of working fluid can be combined and act on turbine blades sets to create maximum torque. One suitable turbine for this application may be provided by blades that are designed to maintain or increase the rotational motion of working fluid. Alternatively, turbine blade sets may be provided in a different configuration (e.g., a different material, differently shaped blades, performing different functions) to achieve different design objectives).

In another embodiment, if a rotational working fluid is maintained during a complete engine cycle, the working fluid flow from cold zone 107b to hot zone 107a may create a rotating updraft. Similarly, a rotational working fluid flow from hot zone 107a to cold zone 107b creates a rotating downdraft. These rotating drafts can be utilized to increase the velocity of the working fluid and power turbine 103. The momentum of the working fluid is continuously increased during each engine cycle, where the hot working fluid meets the cold working fluid. Working fluid under continuously heating, expanding, cooling and contracting in the respective zones during each engine cycle. Therefore, a complete engine cycle and a complete working fluid path are provided within housing 107.

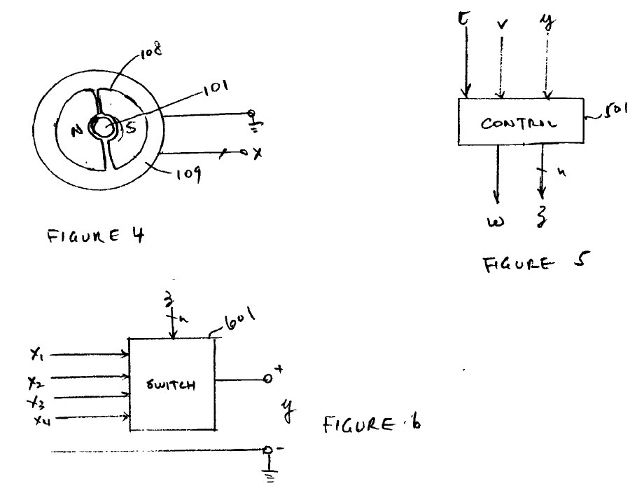

As discussed above, the working fluid has a continuous momentum, resulting from the heating and cooling of the working fluid, and the rotational motion of the blade set 103a and blade set 103b. Turbine 103 rotates due to the working fluid flow and, in turn, drives the working fluid into a rotational motion. In each cycle, the working fluid is accelerated by the combined forces of the vertical rotation downdraft and the rotational uplift. Therefore, under this environment, the longer the engine runs, the faster the working fluid circulates. The working fluid velocity is increased by the kinetic energy, which is then converted by the heat engine into mechanical work. The working fluid is carried more effectively through the working fluid path in the form of a spinning draft. The high fluid velocities result from conservation of angular momentum. The engine design is based on using the continuously heating and cooling pressure to move the working fluid, and to use the working fluid velocity to move the turbine. This design use enhanced working fluid velocity to power a turbine. The operating temperature difference between hot zone 107a and cold zone 107b either by the cooling method discussed above, by controlling the output power, or both. The output power can be controlled by increasing or decreasing the magnetic field coupling between magnet 108 and coils 109 by motor 110 driving coils 109 up or down. A temperature sensor (not shown) sensitive to the temperature difference between hot zone 107a and cold zone 107b may be provided to sense the operating temperature difference. FIG. 5 shows control circuit 501 capable of controlling the output power based on the operating temperature difference. The control scheme may be implemented using digital or analog techniques, as known to those skilled in the art. As shown in FIG. 5, a signal v representing the operating temperature difference is received from the temperature sensor and provided to control circuit 501. Based on the value of signal v, output control signal w drives step motor 110 up or down to vary the magnetic coupling between magnet 108 and coils 109, as appropriate.

For generating AC electrical power, position sensor 112 may be used to detect the rotational frequency of axle 101. Positional sensor 112 asserts a control signal (e.g., control signal t) to control circuit 501 whenever reflector 111 comes into the detection field of positional sensor 112. The time difference between successive assertions of the control signal allows control circuit 501 to determine the frequency of the rotating magnetic field of magnet 108, and thus the frequency of the output AC power.

As mentioned above, for AC power generation, coils 109 need only be a single coil, output terminal y is a single output. Without further processing, the output power is delivered in the form of an AC current flowing between terminal y and the ground terminal, whose frequency is proportional to central axle 101's angular speed of rotation. Because the amount of output power is a load on center axle 101, increasing the amount of magnetic coupling between magnet 108 and coils 109 increases the load on center axle 101, thereby affecting the angular speed of rotation. Accordingly, the output terminal y may be coupled into a high impedance input terminal of control circuit 501, which may be provided a frequency sensing circuit (e.g., a trigger circuit). The detected frequency of the output AC current is used to adjusted through step motor 110, which drives coils 109 up or down according to output control signal w. This control scheme may thus be used to provide an output power from heat engine 110 which is compatible with 50 or 60 Hz household AC power.

In DC power generation, coils 109 may include multiple coils. At any given time, some of terminals x have positive voltages relative to the ground terminal, and others of terminals x have negative voltages relative to the ground terminal. During DC power generation, the position sensor associated with each of coils 109 provides to control circuit 501 control signal t which indicates when the associated reflector comes into the detection field of the position sensor. Once the particular coil of coils 109 is identified as having the desired positive voltage phase, control circuit 501 provides control signals z to switch 601 (FIG. 6) which selectively couples output terminal x of the particular coil to output terminal y. In this manner, DC power generation is accomplished. The signal in output terminal y may be shaped to a constant voltage using, for example, a low-pass filter or a voltage regulator. The heat engine's efficiency, as measurable by axle rotation frequency, for example, determines the efficiency of the DC power generation. The axle rotation frequency can be measured by the time between successive detection signals from a position sensor. The load on the heat engine can be adjusted by varying the magnetic field coupling between the coils and the magnets to maintain a predetermined optimal axle rotation frequency.

The signal in output terminal y may be shaped to a constant voltage using, for example, a low-pass filter or a voltage regulator.

Alternatively, the AC output power generated according to discussion above may be rectified to provide a DC power output, using any suitable rectifier circuits known to those skilled in the art.

Additional energy conversion may be accomplished using thermal couples that provide output signals according to the temperature difference between hot zone 107a and cold zone 107b. Alternatively, the walls of housing 107 at hot zone 107a may be used to generate power using thermionic principles. The thermal couples or thermionic components can be housed insulating zone 106 of FIG. 1, for example.

The above detailed description is provided to illustrate the specific embodiments of the present invention and is not intended to be limiting. Numerous modifications and variations with in the scope of the present invention are possible. The present invention is set forth in the following claims.

We claim:

1. A heat engine, comprising:
a housing enclosing a chamber having a first zone and a second zone with a temperature difference therebetween, the chamber being soaked in a working fluid circulating unobstructed between the first zone and the second zone; and
a plurality of structures in the fluid paths of the chamber, the structures having surfaces in contact with the working fluid, and wherein some of the structures are located in the chamber to cause the working fluid to flow in a circular motion.

2. A heat engine as in claim 1, wherein the working fluid rotates about an axis.

3. A heat engine as in claim 1, wherein the fluid paths include a cyclonic path.

4. A heat engine as in claim 1, wherein the structures comprises a first set of blades coupled to the working fluid such that the first set of blades rotates to generate mechanical power.

5. A heat engine as in claim 4, wherein each blade in the first set of blades has a first surface and a second surface, the first surface and the second surface of each blade having unequal surface areas, such that the first set of blades rotates in a predetermined rotational direction.

6. A heat engine as in claim 1, wherein the structures comprise a support plate to isolate the first zone from the second zone.

7. A heat engine as in claim 1, wherein the structures comprise an axle oriented perpendicular to the cross section of a surface between the first zone and the second zone for power output.

8. A heat engine as in claim 1, wherein the fluid paths include a space for the working fluid moving between the first zone and the second zone.

9. A heat engine as in claim 1, further comprising a step motor for adjusting the output of an electrical generator powering by the heat engine.

10. A heat engine as in claim 9, wherein the step motor taking inputs such as engine temperature and coils position of the electrical generator from a control circuit.

11. A method for providing a heat engine, comprising:
providing a housing encloses a chamber having a first zone and a second zone with a temperature difference therebetween, the chamber being soaked in a working fluid circulating unobstructed between the first zone and the second zone; and
providing a plurality of structures which are in the fluid paths in the chamber, the structures having surfaces in contact with the working fluid, and wherein some of the structures are located in the chamber to cause the working fluid to flow in a circular motion.

12. A method as in claim 11, wherein the working fluid rotates about an axis.

13. A method as in claim 11, wherein the fluid paths include a cyclonic path.

14. A method as in claim 11, wherein the structures comprises a first set of blades coupled to the working fluid, such that the first set of blades rotates to generate mechanical power.

15. A method as in claim 14, wherein each blade in the first set of blades has a first surface and a second surface, the first surface and the second surface of each blade having unequal surface areas, such that the first set of blades rotates in a predetermined rotational direction.

16. A method as in claim 11, wherein the structures further comprise a support plate that isolates the first zone from the second zone.

17. A method as in claim 11, wherein the structures further comprise an axle oriented perpendicular to the cross section of a surface between the first zone and the second zone to output power.

18. A method as in claim 11, wherein the fluid paths include a space for the working fluid moving between the first zone and the second zone.

19. A method as in claim 11, further comprising a step motor to adjust the output of an electrical generator powered by the heat engine.

20. A method as in claim 19, wherein the step motor inputs engine temperature and coils position of the electrical generator into a control circuit.

21. A heat engine having an output power device and a method of enhancing the output power of an electrical generator from the rotational motion of the output power device, the method comprising:
calibrating a performance table relating a rotational speed of the device to an amount of magnetic coupling in a control device within the electrical generator, the amount of magnetic coupling being indicative of the maximum output power of said generator at that temperature difference;
detecting the rotational speed using a rotational speed sensor in the device;
obtaining from the performance table the amount of magnetic coupling corresponding to the rotational speed; and
setting the control device to that amount of magnetic coupling.

22. A heat engine as claim 21, wherein the amount of magnetic coupling is represented by the position of a coil relative to a magnet.

23. A heat engine as in claim 21, wherein the control device communicates with a step motor moving the coil to the desired position.

24. In a heat engine having an output power device and an electrical generator driven by a rotational motion of the output power device, a method for enhancing the output power of an electrical generator of the engine comprising:
calibrating a performance table relating a temperature difference in the device to an amount of magnetic coupling in a control device within the electrical generator, the amount of magnetic coupling being indicative of the maximum output power of said generator at that temperature difference;
detecting the temperature difference using a temperature sensor in the device;
obtaining from the performance table the amount of magnetic coupling corresponding to the temperature difference; and
setting the control device to that amount of magnetic coupling.

25. A heat engine as claim 24, wherein the amount of magnetic coupling is represented by the position of a coil relative to a magnet.

26. A heat engine as claim 24, wherein the control device communicates with a step motor moving the coil to the desired position.

27. A heat engine for mechanical power generation using a heat engine with an enclosed housing, the method comprising:
partitioning the housing into a first zone and a second zone, one zone further adapted from receiving heat from a heat source, and the other zone being further adapted for transferring heat into a heat sink;
providing a turbine having a set of blades having a substantially constant distance to the first zone and coupled to drive an output power device.
providing a working fluid in the first and second zones, wherein the working fluid flows due to the temperature difference between the first zone and the second zone, the working fluid urging the first set of blades, resulting in a rotational motion in the turbine, thereby providing power to drive the axle.
